(19) United States
(12) Patent Application Publication
(10) Pub. No.: US 2018/0028401 A1
(43) Pub. Date: Feb. 1, 2018

(54) DOUBLE-CHAMBER INFUSION BAG AND PRODUCTION METHOD THEREFOR

(71) Applicant: SHANGHAI WUBIN PACKAGING PRODUCTS Co. LIMITED, SHANGHAI (CN)

(72) Inventor: XIAOMIN CHEN, SHANGHAI (CN)

(73) Assignee: SHANGHAI WUBIN PACKAGING PRODUCTS Co. LIMITED

(21) Appl. No.: 15/727,590

(22) Filed: Oct. 7, 2017

Related U.S. Application Data
(63) Continuation of application No. PCT/CN2015/000405, filed on Jun. 15, 2015.

(30) Foreign Application Priority Data
Apr. 10, 2015 (CN) 201510167772.9

(51) Int. Cl. A61J 1/10; B65D 81/32

(52) U.S. Cl. CPC A61J 1/10; B65D 81/32

(57) ABSTRACT

A double-chambered infusion bag includes a sealed soft infusion bag, a first chamber and a second chamber separated by a first peelable strip pseudo soldering structure are formed inside the sealed soft infusion bag. A second peelable strip pseudo soldering structure is provided between the second chamber and an output tube. A breakthrough pressure of the second peelable strip pseudo soldering structure is equal to or greater than a breakthrough pressure of the first peelable strip pseudo soldering structure. A periphery of the second chamber is permanently connected with compound aluminum films or transparent or semi-transparent compound films.

### CROSS-REFERENCE TO RELATED APPLICATIONS

This application is a continuation of International Patent Application No. PCT/CN2015/000405 with a filing date of Jun. 15, 2015, designating the United States, now pending, and further claims priority to Chinese Patent Application No. 201510167772.9 with a filing date of Apr. 10, 2015. The content of the aforementioned applications, including any intervening amendments thereto, are incorporated herein by reference.

### TECHNICAL FIELD

The present application relates to packing technology, particularly relates to medical sealed container, more particularly relates to a sealed container for infusion preparations, and specifically relates to a double-chambered infusion bag and method for producing the same.

### BACKGROUND

In the pharmaceutical industry, it is often required to mix a solid powder medicament with a liquid medicament before being applied to an organism. The mixing operation of the medicaments should be performed under aseptic condition. In order to improve the efficiency and convenience in the mixing operation of the medicaments, a soft infusion bag having two independent chambers was proposed in the prior art, the soft infusion bag has a first chamber, a second chamber, and an output tube. The first chamber is accommodated with the liquid medicament, the second chamber is accommodated with the powder medicament, and the first chamber is separated from the second chamber by a peelable strip pseudo soldering structure arranged between a front bag film and a rear bag film of the soft infusion bag. The peelable strip pseudo soldering structure may be peeled under an increased pressure in the first chamber generated by pressing the bag body at the first chamber, so that the liquid medicament enters the second chamber to realize the mixing operation. Since the output tube is arranged at one side of the first chamber and is always located at a lower end of the soft infusion bag during infusion, while the powder medicament is accommodated inside the second chamber at an upper part of the soft infusion bag, it often occurs that the powder medicament remains in the second chamber and cannot be completely mixed with the liquid medicament, which results in inaccurate dose and waste of the medicaments. In addition, such type of design also easily results in misoperation that the infusion is directly conducted without opening the peelable pseudo soldering structure to allow the solid medicament to be mixed with the liquid medicament, which does not have the treating efficacy.

### SUMMARY

It is an object of the invention to provide a double-chambered infusion bag, and this kind of double-chambered infusion bag aims at, among others, solving the technical problem that in the prior art, the similar infusion bags have power medicament residue, and cannot be, or cannot be completely, mixed with the liquid medicament.

A double-chambered infusion bag of the present application comprises a sealed soft infusion bag, the soft infusion bag comprising a piece of a front bag film, a piece of a rear bag film, and an output tube. The front bag film and the rear bag film are both rectangular, the front bag film and the rear bag film are permanently connected at peripheries thereof by a permanent soldered structure, the front bag film and the rear bag film are provided therebetween with a first chamber and a second chamber, the first chamber and the second chamber are arranged from the top downward along a lengthwise direction of the soft infusion bag, the first chamber and the second chamber are separated by a first peelable strip pseudo soldering structure arranged between the front bag film and the second bag film, the first chamber is accommodated with a liquid medicament, the second chamber is accommodated with a powder medicament, the output tube is arranged at a lower end of the soft infusion bag, the output tube is separated from the second chamber via a second peelable strip pseudo soldering structure arranged between the front bag film and the rear bag film, a breakthrough pressure of the second peelable strip pseudo soldering structure is equal to or greater than a breakthrough pressure of the first peelable strip pseudo soldering structure; and a striated structure is defined on a surface of the front bag film facing the rear bag film, or, a striated structure is defined on a surface of the rear bag film facing the front bag film, or, striated structures are respectively defined on a surface of the front bag film and a surface of the rear bag film that face each other.

Further, a periphery of the output tube is permanently connected with the front bag film and the rear bag film via the permanent soldered structure.

Further, a width of the second chamber is smaller than a width of the first chamber.

Further, outer peripheries of the front bag film and the rear bag film of the second chamber are permanently connected with compound aluminum films or transparent or semi-transparent compound films with barrier properties having silica or alumina plating layers, and the permanent connection of at least one outer side is able to be peeled under a certain external force.

The present application further provides a method for producing the double-chambered infusion bag, and the method comprises a process of soldering the front bag film and the rear bag film, in which, during the process of soldering the front bag film and the rear bag film, the front bag film and the rear bag film are permanently connected at peripheries thereof by the permanent soldered structure to form the soft infusion bag, at least one first peelable strip pseudo soldering structure and at least one second peelable strip pseudo soldering structure are processed between the front bag film and the rear bag film to form the first chamber and the second first chamber from the top downward, meanwhile, the output tube is fixed at the lower end of the soft infusion bag, and the second peelable strip pseudo soldering structure is used to separate an upper end of the output tube from the second chamber, after the front bag film and the rear film are soldered, the liquid medicament is filled into the first chamber and the first chamber is sealed; the soft infusion bag and the output tube are then sterilized and dried; thereafter, one side of the soft infusion bag is cut to form a second channel at one side of the second chamber, the power medicament is filled into the second chamber via the second channel; and the second channel is sealed after the filling of the powder medicament.

Further, in the step of permanent connection of the front bag film and the rear bag film at the peripheries thereof via the permanent soldered structure, a first channel for introducing the liquid medicament is reserved at an upper end of the front bag film and an upper end of the rear bag film.

Further, after the filling of the power medicament and the sealing of the second channel, outer sides of the soft infusion bag are permanently connected with compound aluminum films or transparent or semi-transparent compound films with barrier properties having silica or alumina plating layers, and the permanent connection of at least one outer side is able to be peeled under a certain external force.

Further, a periphery of the soft infusion bag is performed with punching modification.

Working principle of the present application is as follows: the first chamber is separated from the second chamber via the first peelable strip pseudo soldering structure. In use, the soft infusion bag is squeezed to allow the liquid medicament in the first chamber to pierce the first peelable strip pseudo soldering structure to enter the second chamber where the liquid medicament is mixed with the powder medicament, the squeeze of the soft infusion bag is continued, mixed medicaments in the first chamber and the second chamber pierce the second peelable strip pseudo soldering structure to enter the output tube, and are then output via an infusion tube that is inserted into the output tube.

Compared with the prior art, effects of the present application is positive and obvious. The present application arranges the second chamber accommodating the powder medicament between the first chamber accommodating the liquid medicament and the output tube for outputting the medicaments, thus ensuring the complete mixing of the powder medicament and the liquid medicament. The breakthrough pressure of the peelable strip pseudo soldering structure that is adjacent to the liquid medicament accommodated chamber is smaller than or equal to the breakthrough pressure of the peelable strip pseudo soldering structure that is adjacent to the output tube, thus ensuring that the powder medicament is mixed with the liquid medicament in advance before entering the output tube.

### BRIEF DESCRIPTION OF THE DRAWINGS

FIG. 1 is a structural schematic diagram of a double-chambered infusion bag;

FIG. 2 is a schematic diagram of a step of bag fabrication in a process for preparing the double-chambered infusion bag;

FIG. 3 is a schematic diagram of a step of filling of a liquid medicament in the process for preparing the double-chambered infusion bag;

FIG. 4 is a schematic diagram of a step of sterilization in the process for preparing the double-chambered infusion bag;

FIG. 5 is a schematic diagram of a step of cutting of one side of the second chamber in the process for preparing the double-chambered infusion bag;

FIG. 6 is a schematic diagram of a step of filling of a powder medicament in the process for preparing the double-chambered infusion bag;

FIG. 7 is a schematic diagram of a step of attaching of aluminum films in the process for preparing the double-chambered infusion bag;

FIG. 8 is a schematic diagram of a step of punching modification in the process for preparing the double-chambered infusion bag;

FIGS. 9a-9c are structural schematic diagrams showing front and rear bag films for preparing the double-chambered infusion bag;

FIGS. 10a and 10b are structural schematic diagrams of a striated structure.

### DETAILED DESCRIPTION OF THE EMBODIMENTS

### Example 1

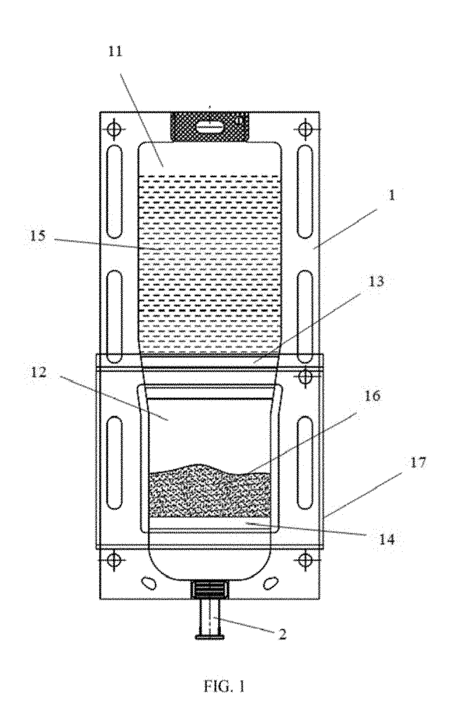

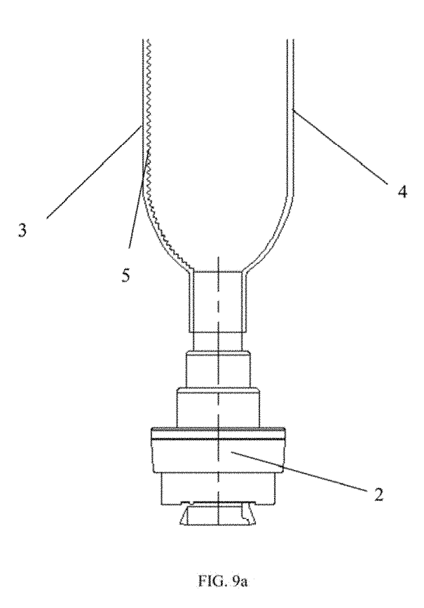

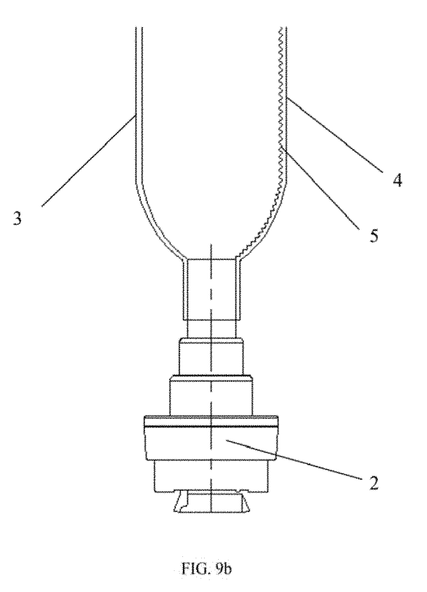

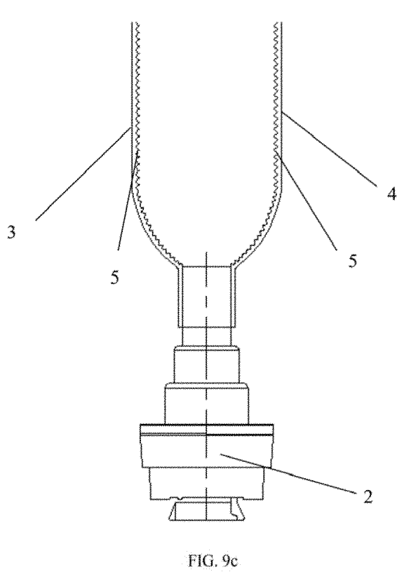

As shown in FIGS. 1 and 9a, a double-chambered infusion bag of the present application comprises a sealed soft infusion bag 1. The soft infusion bag 1 comprises a piece of a front bag film 3, a piece of a rear bag film 4, and an output tube 2. The front bag film 3 and the rear bag film 4 are both rectangular. The front bag film 3 and the rear bag film 4 are permanently connected at peripheries thereof by a permanent soldered structure. The front bag film 3 and the rear bag film 4 are provided therebetween with a first chamber 11 and a second chamber 12. The first chamber 11 and the second chamber 12 are arranged from the top downward along a lengthwise direction of the soft infusion bag 1, in which, the first chamber 11 and the second chamber 12 are separated by a first peelable strip pseudo soldering structure 13 that are arranged between the front bag film 3 and the rear bag film 4. The first chamber 11 is accommodated with a liquid medicament 15, and the second chamber 12 is accommodated with a powder medicament 16. The output tube 2 is arranged at a lower end of the soft infusion bag 1. The output tube 2 is separated from the second chamber 12 via a second peelable strip pseudo soldering structure 14 arranged between the front bag film 3 and the rear bag film 4. A breakthrough pressure of the second peelable strip pseudo soldering structure 14 is equal to or greater than a breakthrough pressure of the first peelable strip pseudo soldering structure 13, and a width of the second chamber 12 is smaller than a width of the first chamber 11.

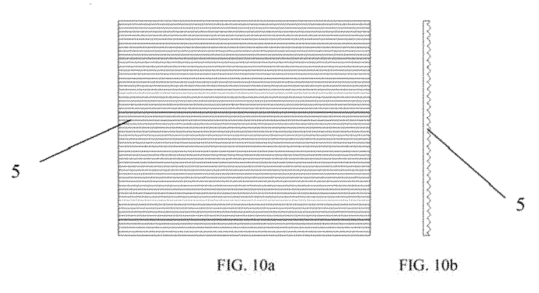

Further, as shown in FIGS. 9a-9c, 10a and 10b, a striated structure 5 is defined on a surface of the front bag film 3 facing the rear bag film 4, or, a striated structure 5 is defined on a surface of the rear bag film 4 facing the front bag film 3, or, striated structures 5 are respectively defined on a surface of the front bag film 3 and a surface of the rear bag film 4 that face each other. With the striated structure 5, a sterilization process of 121° C. can be adopted to produce the double-chambered infusion bag. The striated structure 5 is capable of preventing the front and rear bag films 3 and 4 from adhering to each other when performing sterilization under 121° C. At the same time, steam will enter into the cavity of the striated structure 5 when performing sterilization under 121° C. so as to perform moist-heat sterilization in the infusion bag. The sterilization process of 121° C. is the most economical and safe process for producing the double-chambered infusion bag. Without the striated structure 5, it can adopt a sterilization process of 107° C. However, the sterilization effect is also watered-down and more time is needed for sterilization which will directly affect production efficiency. Alternatively, without the striated structure 5, a ray sterilization process may be adopted. However, this sterilization process is expensive and will bring a risk of exposure to radiation to operators.

Further, a periphery of the output tube 2 is permanently connected with the front bag film and the rear bag film via the permanent soldered structure.

Further, outer peripheries of the front bag film and the rear bag film of the second chamber are permanently connected with compound aluminum films or transparent or semi-transparent compound films 17 with barrier properties having silica (SiO2) or alumina (Al2O3) plating layers, and the permanent connection of at least one outer side is able to be peeled under a certain external force.

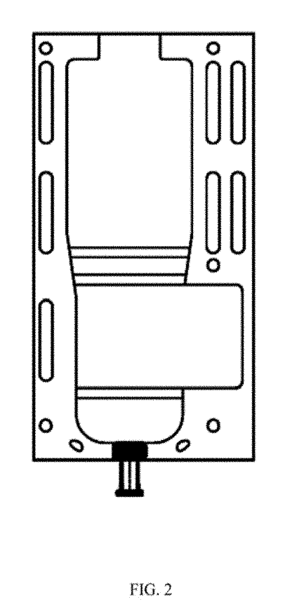

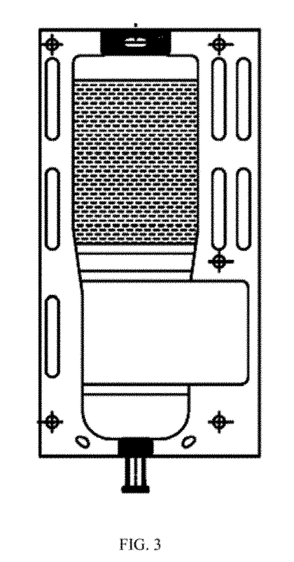

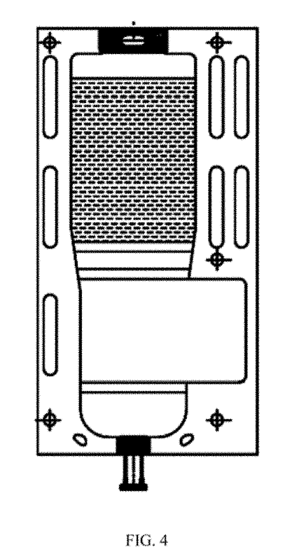

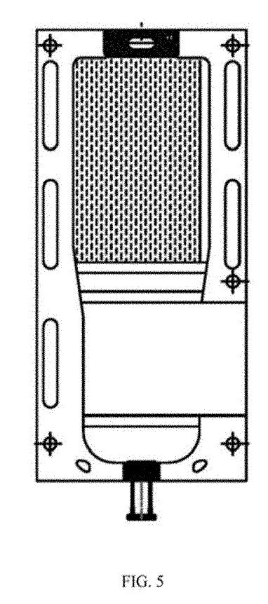

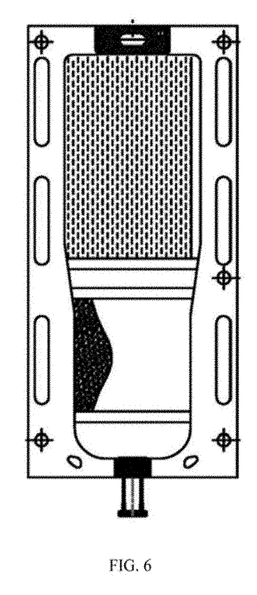

A method for producing the above double-chambered infusion bag, the method comprises a process of soldering the front bag film and the rear bag film, in which, as shown in FIG. 2, during the process of soldering the front bag film and the rear bag film, the front bag film and the rear bag film are permanently connected at peripheries thereof by the permanent soldered structure to form the soft infusion bag 1, the a first peelable strip pseudo soldering structure 13 and the at least one second peelable strip pseudo soldering structure 14 are processed between the front bag film and the rear bag film to form the first chamber 11 and the second first chamber 12 from the top downward, meanwhile, the output tube 2 is fixed at the lower end of the soft infusion bag 1, and the second peelable strip pseudo soldering structure 14 is used to separate an upper end of the output tube 2 from the second chamber 12. As shown in FIG. 3, after the front bag film and the rear film are soldered, the liquid medicament is filled into the first chamber 11 and the first chamber 11 is then sealed. As shown in FIG. 4, the soft infusion bag 1 and the output tube 2 are then sterilized and dried. As shown in FIG. 5, thereafter, one side of the soft infusion bag 1 is cut to form a second channel at one side of the second chamber 12, the power medicament 16 is filled into the second chamber 12 via the second channel, as shown in FIG. 6, the second channel is sealed after the filling of the powder medicament 16.

Further, in the step of permanent connection of the front bag film and the rear bag film at the peripheries thereof via the permanent soldered structure, a first channel for introducing the liquid medicament is reserved at an upper end of the front bag film and an upper end of the rear bag film.

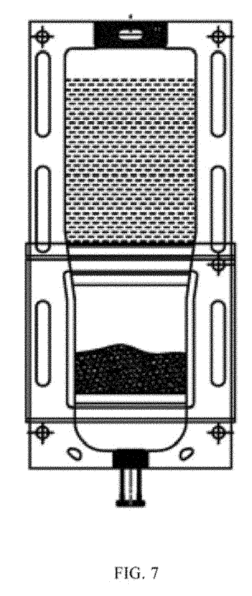

As shown in FIG. 7, further, after the filling of the power medicament 16 and the sealing of the second channel, outer sides of the soft infusion bag 1 are attached with aluminum films 17.

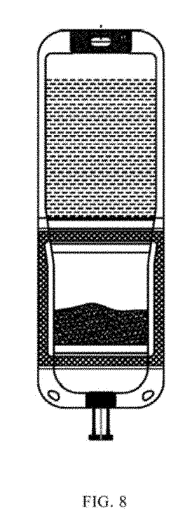

As shown in FIG. 8, further, a periphery of the soft infusion bag 1 is performed with punching modification.

Working principle of the present example is as follows: the first chamber 11 is separated from the second chamber 12 via the first peelable strip pseudo soldering structure 13. In use, the soft infusion bag 1 is squeezed to allow the liquid medicament 15 in the first chamber 11 to pierce the first peelable strip pseudo soldering structure 13 to enter the second chamber 12 where the liquid medicament 15 is mixed with the powder medicament 16, the squeeze of the soft infusion bag 1 is continued, mixed medicaments in the first chamber 11 and the second chamber 12 pierce the second peelable strip pseudo soldering structure 14 to enter the output tube 2, and are then output via an infusion tube that is inserted into the output tube 2.

What is claimed is:

1. A double-chambered infusion bag, comprising a sealed soft infusion bag, the soft infusion bag comprising a piece of a front bag film, a piece of a rear bag film, and an output tube, wherein the front bag film and the rear bag film are both rectangular, the front bag film and the rear bag film are permanently connected at peripheries thereof by a permanent soldered structure, the front bag film and the rear bag film are provided therebetween with a first chamber and a second chamber, the first chamber and the second chamber are arranged from the top downward along a lengthwise direction of the soft infusion bag, the first chamber and the second chamber are separated by a first peelable strip pseudo soldering structure arranged between the front bag film and the second bag film, the first chamber is accommodated with a liquid medicament, the second chamber is accommodated with a powder medicament, the output tube is arranged at a lower end of the soft infusion bag, the output tube is separated from the second chamber via a second peelable strip pseudo soldering structure arranged between the front bag film and the rear bag film, a breakthrough pressure of the second peelable strip pseudo soldering structure is equal to or greater than a breakthrough pressure of the first peelable strip pseudo soldering structure; and a striated structure is defined on a surface of the front bag film facing the rear bag film, or, a striated structure is defined on a surface of the rear bag film facing the front bag film, or, striated structures are respectively defined on a surface of the front bag film and a surface of the rear bag film that face each other.

2. The double-chambered infusion bag of claim 1, wherein a periphery of the output tube is permanently connected with the front bag film and the rear bag film via the permanent soldered structure.

3. The double-chambered infusion bag of claim 1, wherein a width of the second chamber is smaller than a width of the first chamber.

4. The double-chambered infusion bag of claim 1, wherein outer peripheries of the front bag film and the rear bag film of the second chamber are permanently connected with compound aluminum films or transparent or semi-transparent compound films with barrier properties having silica or alumina plating layers, and the permanent connection of at least one outer side is able to be peeled under a certain external force.

5. A method for producing the double-chambered infusion bag of claim 1, the method comprising a process of soldering the front bag film and the rear bag film, wherein, during the process of soldering the front bag film and the rear bag film, the front bag film and the rear bag film are permanently connected at peripheries thereof by the permanent soldered structure to form the soft infusion bag, at least one first peelable strip pseudo soldering structure and at least one second peelable strip pseudo soldering structure are processed between the front bag film and the rear bag film to form the first chamber and the second first chamber from the top downward, meanwhile, the output tube is fixed at the lower end of the soft infusion bag, and the second peelable strip pseudo soldering structure is used to separate an upper end of the output tube from the second chamber; after the front bag film and the rear film are soldered, the liquid medicament is filled into the first chamber and the first chamber is sealed; the soft infusion bag and the output tube are then sterilized and dried; thereafter, one side of the soft infusion bag is cut to form a second channel at one side of the second chamber, the power medicament is filled into the second chamber via the second channel; and the second channel is sealed after the filling of the powder medicament.

6. The method of claim 5, wherein in the step of permanent connection of the front bag film and the rear bag film at the peripheries thereof via the permanent soldered structure, a first channel for introducing the liquid medicament is reserved at an upper end of the front bag film and an upper end of the rear bag film.

7. The method of claim 5, wherein after the filling of the power medicament and the sealing of the second channel, outer sides of the soft infusion bag are permanently connected with compound aluminum films or transparent or semi-transparent compound films with barrier properties having silica or alumina plating layers, and the permanent connection of at least one outer side is able to be peeled under a certain external force.

8. The method of claim 7, wherein a periphery of the soft infusion bag is performed with punching modification.
